(19) United States
(12) Patent Application Publication
(10) Pub. No.: US 2024/0246460 A1
(43) Pub. Date: Jul. 25, 2024

(54) Connector Between Car Seat Shell And Base

(71) Applicant: Evenflo Company, Inc., Miamisburg, OH (US)

(72) Inventors: Jessica POPELKA, Charlotte, NC (US); Shain Saucier, Charlotte, NC (US)

(21) Appl. No.: 18/415,316

(22) Filed: Jan. 17, 2024

Related U.S. Application Data
(60) Provisional application No. 63/441,081, filed on Jan. 25, 2023.

(51) Int. Cl. B60N 2/28

(52) U.S. Cl. CPC B60N 2/2821

(57) ABSTRACT

Embodiments of the present disclosure include a car seat comprising a base, a seat shell, and a connector having a first end secured to the base and a second end secured to the seat shell. In a first position, the seat shell and the base are coupled. In a second positon, the seat shell may be uncoupled from the base. The connector maintains a connection between the base and the seat shell when in the second position.

### CROSS-REFERENCE TO RELATED APPLICATIONS

This application claims the benefit of U.S. Provisional Application No. 63/441,081 filed on Jan. 25, 2023, the entirety of which is hereby incorporated by reference.

### BACKGROUND

In the United States, child car seats are required by law and recommended for children of certain ages or sizes. There are many types of car seats available for purchase. Infant car seats recommended for children under age 1 are typically rear-facing. Many infant car seats include a base that is belted or tethered into the car and a seat that may latch into the base. Some car seats have a seat shell that holds the child occupant and a base supporting the seat shell, where the seat shell may be removed from the base to reach particular areas of the base and/or seat shell, such as to reach the belt path, belt tensioner (e.g., strong arm), or tethers to connect the car seat to a vehicle seat. While easier access to installation parts may ensure a more secure and safer installation as well as provide a better user experience, keeping the seat shell uncoupled from the base during use is unsafe. As such, it would be desirable to provide a car seat that may be separated from the base while maintaining some connection to prevent unintended use of the car seat.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several examples in accordance with the disclosure and are, therefore, not to be considered limiting of its scope, the disclosure is described with additional specificity and detail below through the use of the accompanying drawings.

FIG. 1 is a perspective view of a car seat in accordance with an embodiment disclosed herein.

FIG. 2 is a side view of the car seat of FIG. 1 in a forward-facing position.

FIG. 3 is an exploded view of the car seat of FIG. 1 in the forward-facing position.

FIG. 4A is a perspective view of the car seat of FIG. 1 with the seat shell uncoupled from the base.

FIG. 4B is an exploded view of the car seat of FIG. 1 with the seat shell uncoupled from the base.

FIG. 5 is a bottom view of the base of the car seat of FIG. 1.

FIG. 6A is a cross-sectional view of the car seat of FIG. 1 taken at cutline 6-6 in FIG. 1.

FIG. 6B is the cross-sectional view of the car seat of FIG. 1 taken at cutline 6-6 in FIG. 1 with a close-up view of the second end of the connector.

FIG. 6C is the cross-sectional view of the car seat of FIG. 1 taken at cutline 6-6 in FIG. 1 with a close-up view of another embodiment of the connector.

FIG. 7 is a cross-sectional view of the car seat of FIG. 1 taken at cutline 7-7 in FIG. 1.

FIGS. 8A-8C are side and perspective views of the car seat of FIG. 1 as the seat shell rotates from the forward-facing positon to a rearward-facing position.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

It should be noted that some of the terms used herein may be relative terms. For example, the terms “upper” and “lower” and the terms “forward” and “rearward” or are relative to each other in location, i.e. an upper component is located at a higher elevation than a lower component in a given orientation, but these terms may change if the device is flipped. An intermediate component, on the other hand, is always located between an upper component and a lower component regardless of orientation. The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other. The terms “top” and “bottom” or “base” are used to refer to surfaces where the top is always higher than the bottom/base relative to an absolute reference, i.e. the surface of the earth. The terms “upwards” or “upwardly” and “downwards” or “downwardly” are also relative to an absolute reference; upwards is always against the gravity of the earth. The terms “forward” and “rearward” or “rear” with respect to a position or orientation are opposite one another along a common direction, and an “intermediate” position is always located between a forward position and a rearward position. The term “parallel” should be construed in its lay sense of two surfaces that maintain a generally constant distance between them, and not in the strict mathematical sense that such surfaces will never intersect when extended to infinity. The terms “operative to” and “adapted to” and similar terms are used herein to describe that a particular component has certain structural features designed to perform a designated function. Such components should be construed as having the expressed structure, with the designated function being considered part of the structure. The term “engage” and similar terms are used herein to describe the interaction between particular components and does not necessarily require that such components contact one another (directly or indirectly). As used herein and as will be appreciated by those skilled in the art, the term “car seat” encompasses car seats, safety seats, restraints, boosters, and the like for children, infants, and toddlers and the like.

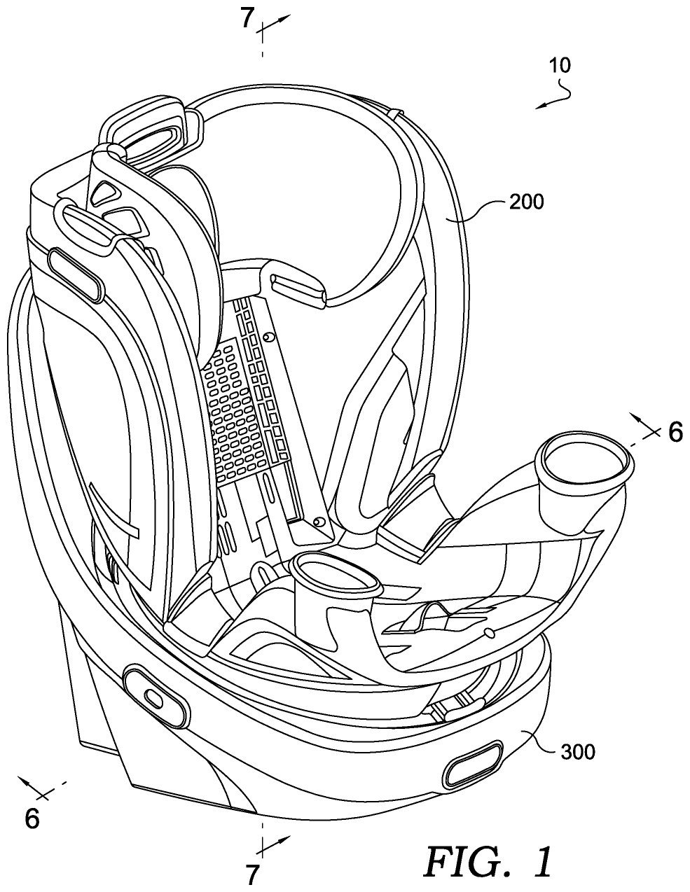

In accordance with aspects of the disclosure, exemplary embodiments of car seats are illustrated in various levels of specificity in FIGS. 1-8C. As will be appreciated by those skilled in the art, the car seats described herein may be convertible car seats that are convertible between at least two configurations. For example, a car seat described herein may be convertible between a forward-facing configuration and a rearward-facing configuration. In another example, a car seat described herein is convertible between a forward-facing configuration and a rearward-facing configuration, and a booster configuration. In yet another example, a car seat described herein is convertible between a forward-facing configuration and a rearward-facing configuration, a high-back booster configuration, and a backless booster configuration. The car seats of the present disclosure may be configured to support an infant, child, toddler, or the like.

Very generally, car seat 10 is designed for safely transporting an infant or child in a vehicle, such as a car. As illustrated in FIG. 1, the car seat 10 generally includes a seat shell 200, which is supported on a base 300.

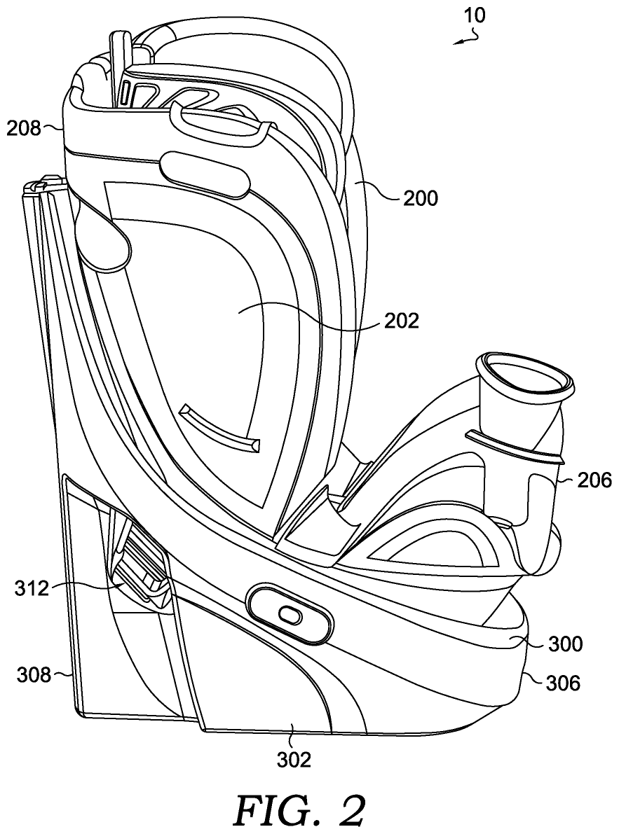

Now referring to FIG. 2, as will be readily understood by those skilled in the art, the car seat 10 (and, namely, the base 300) may be affixed to the seat of a car, such as by a seat belt (e.g., lap belt) of the car extending through a belt path 312. The seat shell 200 may include a forward end 206 and a rear end 208 opposite the forward end 206. The base 300 may include a first side 302 and a second side 304 opposite the first side 302. The base 300 may further include a forward end 306 and a rear end 308 opposite the forward end 306.

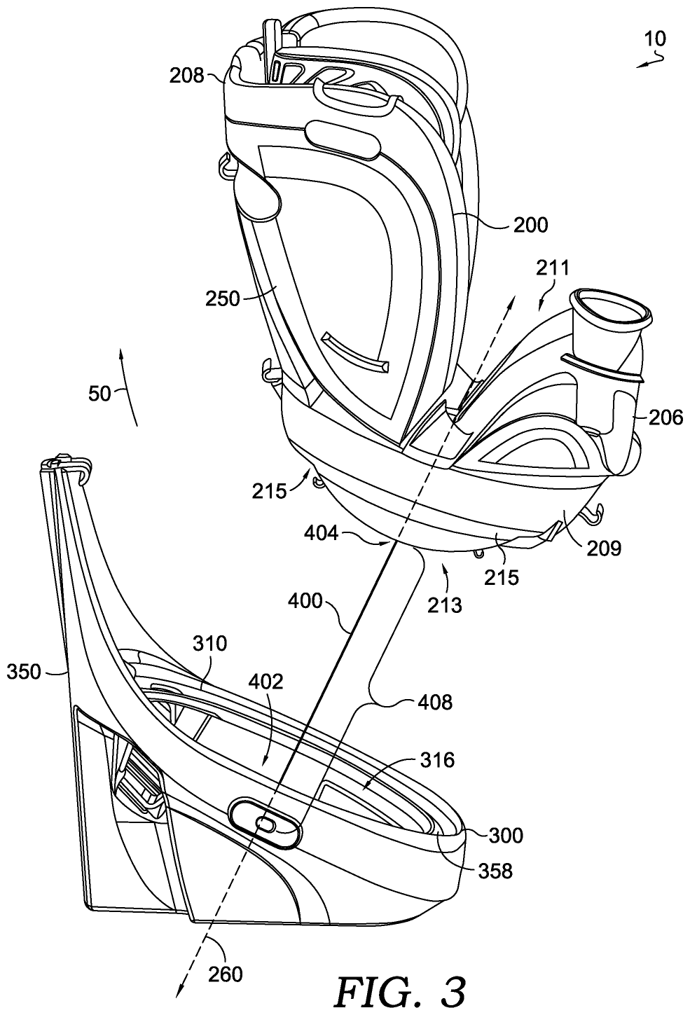

Now referring to FIG. 3, the base 300 may support and stabilize the seat shell 200. In particular, the base 300 may include a receiving portion 310 that generally operates to support the seat shell 200 on the base 300, which may be supported on a seat of a vehicle. For example, at least a portion of the seat shell 200 may be received by and/or within the receiving portion 310 of the base 300. Put another way, the receiving portion 310 of the base 300 may be configured to interface with at least a portion of the seat shell 200. More specifically, the receiving portion 310 may be configured to interface with the seat shell 200 on a bottom side 213 of the seat shell 200. It is contemplated that the base 300 may comprise a single structure or multiple structures that are secured together that they could not be uncoupled by a user. However, it is also contemplated that the term “base” used herein may include the combination of a base structure configured to sit on the seat of a vehicle and an intermediate structure that may be configured to be selectively removed from the base structure by a user.

The seat shell 200 includes a seat bottom 209 and a seat back 250. The seat bottom 209 of the seat shell 200 may generally operate as a seating surface for the occupant by supporting and stabilizing the seat of the occupant. For example, an occupant may be seated on a top side 211 of the seat bottom 209 of the seat shell 200. The seat back 250 may extend upwardly away from the seat bottom 209, such as extending upwardly from the seat bottom 209 proximate the rear end 208 of the seat shell 200. In some aspects, the base 300 also includes a backing portion 350 that extends upwardly away (i.e., in the direction of arrow 50) from the receiving portion 310, such as extending upwardly from the receiving portion 310 proximate the rear end 308 of the base 300. The backing portion 350 may assist in supporting the seat back 250.

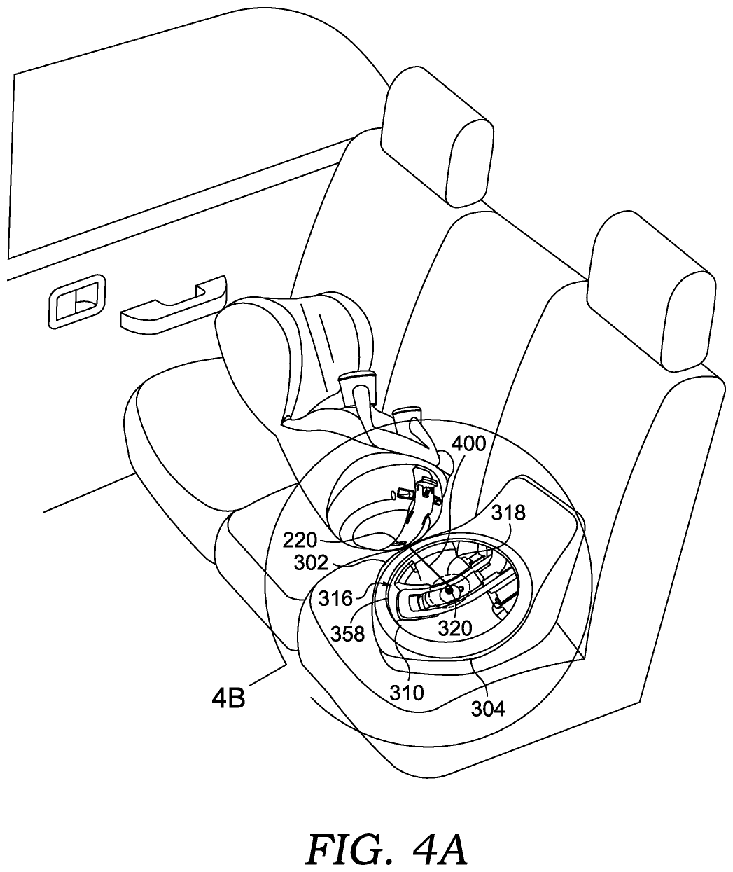

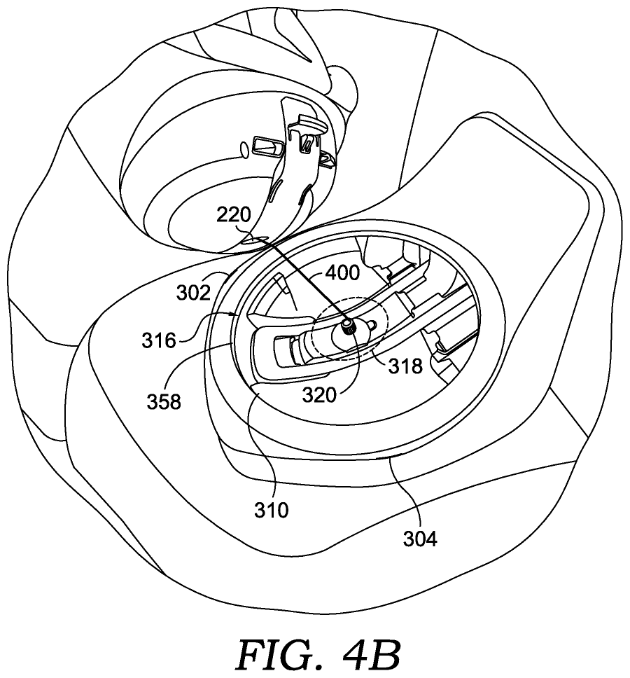

As shown in FIGS. 3 and 4, the receiving portion 310 of the base 300 may be curved or concave so as to at least partially define a bowl shape. In this way, the receiving portion 310 of the base 300 generally defines a cavity 316 that is sized and shaped to receive at least a portion of the seat shell 200. In some embodiments and as described further herein, the seat shell 200 may be rotatable and/or reclinable with respect to the base 300 such that the base 300 may operate to support the seat shell 200 for rotation and/or reclining with respect thereto. In some aspects, the seat shell 200 may be rotatable with respect to the base 300 while the seat shell 200 is secured within the cavity 316 of the base 300. In other aspects, the seat shell 200 is rotatable with respect to the base 300 in that the seat shell 200 may be arranged in different orientations (e.g., forward facing, rearward facing) relative to the base 300 but the seat shell 200 may be removed from the cavity 316 of the base 300 during repositioning to a different orientation.

As described in more detail herein, the seat shell 200 may be configured to be uncoupled from the base 300. In other words, the seat shell 200 may be in a first position in which at least part of a lower surface 215 of the bottom side 213 of the seat bottom 209 abuts a surface of the base 300 in the receiving portion 310, such as the configuration shown in FIG. 2. The seat shell 200 may be partially removed from the base 300 such that, in a second position, the bottom side 213 of the seat shell 200 is separated from the surface of the receiving portion 310, such as the configurations shown in FIGS. 3 and 4A-4B, while one or more features may keep the seat shell 200 not entirely separable from the base 300 as further described herein.

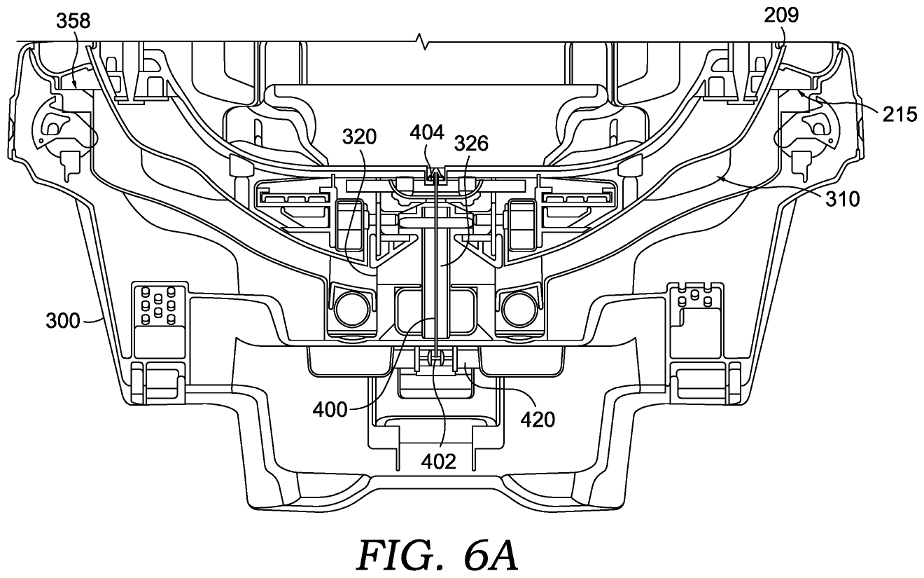

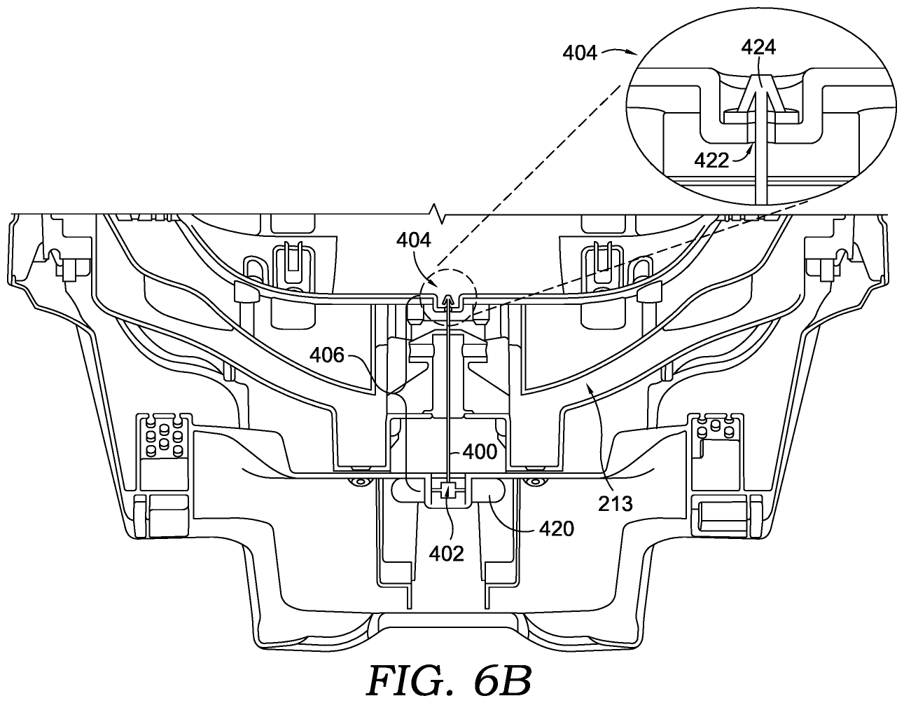

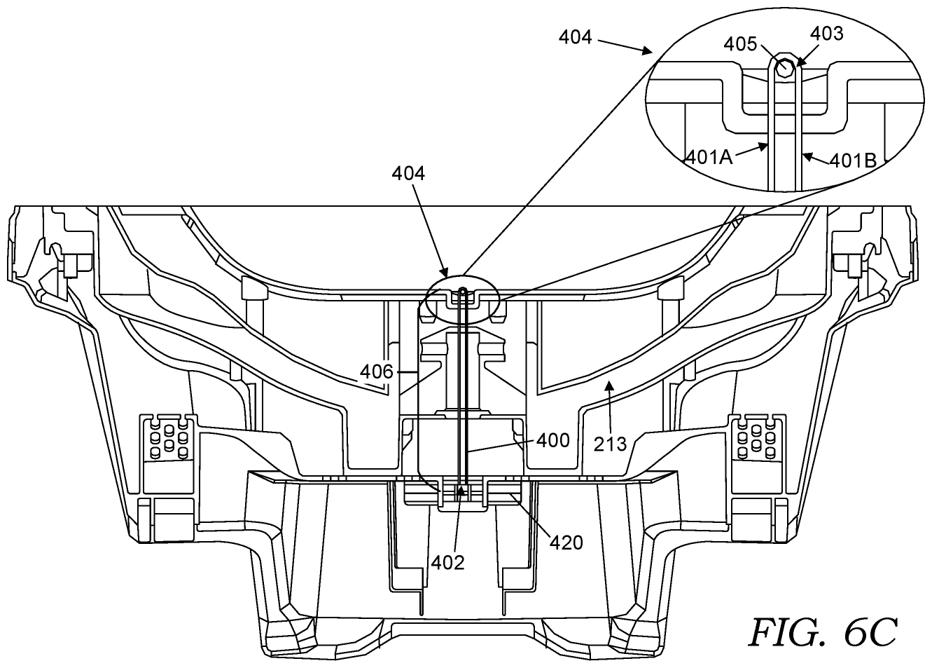

As shown in FIGS. 3, 4A-B, and 6A, the receiving portion 310 of the base 300 includes a support surface 358, which may also be referred to as a support ledge. As shown in FIG. 6A, when the seat shell 200 is in the first position (coupled to the base 300), the lower surface 215 of the seat bottom 209 abuts the support surface 358 of the base 300. In some embodiments, the seat shell 200 rotates with respect to the base 300, and the support surface 358 generally operates as a surface along which at least the seat shell 200 travels as the seat shell 200 is rotated with respect to the base 300. In this way, the support surface 358 may be viewed as a track along which the seat shell 200 rotates. As can be appreciated, the support surface 358 may be an arcuate track. More specifically, in some embodiments, the support surface 358 is circular in shape and may define an opening to the cavity 316 of the receiving portion 310 of the base 300.

As shown in FIGS. 4A-4B and 6A, a central portion 318 of the receiving portion 310 of the base 300 includes a projection 320, which may also be referred to herein as a pedestal. The projection 320 extends upwardly from an inner surface of the receiving portion 310 of the base 300. Further, the bottom side 213 of the seat bottom 209 includes a cavity 220 that receives at least a portion of the projection 320 of the base 300 when the seat shell 200 is coupled to the base 300 in the first position. The projection 320 may have one or more flanges that engage with slots on the seat shell 200 so secure the seat shell 200 and the base 300 together. In embodiments in which the seat shell 200 rotates relative to the base 300, the seat shell 200 may rotate about the projection 320. In some aspects, the seat shell 200 is primarily supported by the base 300 through the coupling of the seat shell 200 to the projection 320 while the support surface 358 of the base 300 merely guides the lower surface 215 of bottom 209 as the seat shell 200 rotates relative to the projections 320.

In a first position, as shown in FIG. 1, the seat shell 200 abuts surfaces of the receiving portion 310 of the base 300, and in a second position, as shown in FIGS. 4A-4B, the seat shell 200 is removed from the base 300 such that surfaces of the bottom side 213 of the seat shell 200 no longer abut (i.e., are spaced apart from) surfaces of the receiving portion 310 of the base 300. As such, the lower surface 215 of the seat bottom 209 may no longer abut the support surface 358 of the base 300. Additionally, in the second position, the projection 320 of the base 300 is removed from the cavity 220 of the seat shell 200, as shown in a close-up view in FIG. 4B.

Aspects of the car seat 10 include a connector 400 that maintains at least an indirect connection between the seat shell 200 and the base 300. In other words, the seat shell 200 and the base 300 may be indirectly coupled via the connector 400 in both the first position and the second position.

The connector 400 has a first end 402 and a second end 404 opposite the first end 402. The first end 402 of the connector 400 is secured to the base 300 and the second end 404 is secured to seat shell 200. In exemplary aspects, the second end 404 is secured to the bottom side 213 of the seat bottom 209. In other aspects, the second end 404 is secured to another portion of the seat shell 200, such as a back side, right side, left side, or front side of the seat bottom 209 or to the seat back 250.

In some aspects, the second end 404 of the connector 400 is attached to the seat shell 200 on the bottom side 213 of the seat bottom 209. In this way, the connector 400 may be entirely within the receiving portion 310 of the base 300 when the seat shell 200 is in the first (coupled) position. Advantageously, ensuring the connector 400 is retained within the receiving portion 310 prevents the connector 400 from being caught on something during use or during a crash event and also provides a more pleasing look than a connector 400 that is visible when the seat shell 200 is coupled to the base 300.

The connector 400 is configured to be not easily removed from the seat shell 200 and base 300 by a user such that a special tool may be needed to remove the connector 400. In this way, the connector 400 ensures that a user cannot completely separate the seat shell 200 from the base 300 to use the car seat 10 in an unintended and unsafe manner. At the same time, the connector 400 is configured to allow some separation of the seat shell 200 from the base 300, which may be advantageous to reach portions of the car seat 10 needed for installation, such as to reach portions of the belt path 312 to thread a vehicle belt or tether for installation and/or to reach a belt tensioner. In this way, the connector 400 may be referred to a tether between the seat shell 200 and the base 300.

To allow for some separation between the seat shell 200 and the base 300, the connector 400 is configured to move from a non-extended position and an extended positon. The connector 400 may have a longer length in the extended position than in the non-extended position. When the seat shell 200 is coupled to the base 300 in the first position, the connector 400 may be in a non-extended position, and when the seat shell 200 is removed from the receiving portion 310 of the base 300 in the second position, the connector 400 may be in an extended position. In exemplary aspects, the connector 400 is made from a flexible material and may be referred to herein as a flexible connector. Such flexible material may be material that can be flexed, curved, or bent along some portion of the body of the connector 400. Examples of a flexible connector 400 include an elongated flexible plastic structure, a textile webbing, a cord, a rope, a cable, and the like. In some aspects, the connector 400 moves from a non-extended position to an extended position simply by being flexed. In other words, the connector 400 may have slack in the non-extended position (which may be due to the presence of curves, bends, folds, etc.) and may have no slack (i.e., be taut) or less slack in the extended position. In other aspects, the connector 400 may be formed from a more rigid structure, such as a rigid plastic or a metal.

In other aspects, the connector 400 is retractable such that the non-extended position of the connector 400 is a retracted position and the extended position is a non-retracted position. As such, the connector 400 may have a first length 406 when in the retracted position (see FIG. 6B) and a second or greater length 408 when in the extended position (see FIG. 3). In some aspects, the connector 400 may have a telescoping structure to move between non-retracted and retracted positions. In other aspects, the connector 400 is attached to a spool 420 that is biased to be wound up, and the bias may be overcome by a user lifting or otherwise pulling on the seat shell 200 or base 300 to apply tension to the connector 400, thereby unwinding at least some length of the connector 400 from a spool 420. In exemplary aspects, the connector 400 is a retractable cable.

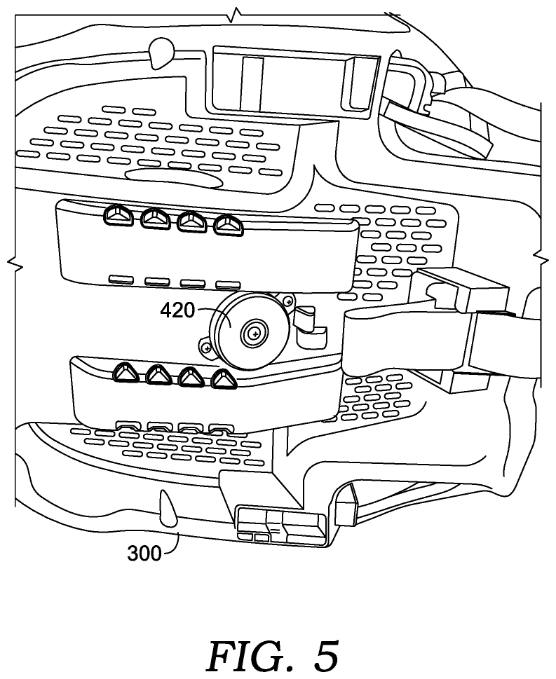

As illustrated in FIG. 6B, the spool 420 is connected to at least one of the first end 402 and the second end 404 of the connector 400. In this example depicted, the spool 420 is positioned in the base 300 and is secured to the first end 402 of the connector 400. FIG. 5 provides a bottom view of the base 300, and the spool 420 is visible as it attaches to the bottom of the base 300 in one example embodiment. As shown in the cross-sectional views of FIGS. 6A and 6B, a channel 326 extends through the base 300 from the bottom side of the base 300 to the receiving portion 310. The spool 420 is positioned behind a lower opening to the channel 326, and the connector 400 extends from the spool 420 and into the channel 326. The connector 400 extends through an upper opening of the channel 326 to exit the base 300 and connect to the seat shell 200. In some aspects, the channel 326 through which the connector 400 extends is at least partially within the projection 320 of the base 300 such that the connector 400 exits the base 300 through the top of the projection 320 and is received within the cavity 220 on the bottom side 213 of the seat bottom 209.

While the spool 420 is depicted in FIG. 5 as being positioned on a bottom side of the base 300 such that it is visible in a bottom up view, it is contemplated that aspects herein may include the spool 420 being entirely contained within the body of the base 300 or may be at least partially located on the opposite side (i.e., top side) of the base 300 in the receiving portion 310. Additionally, it is contemplated that other aspects may have the spool 420 located in the seat bottom 209 or other part of the seat shell 200 such that the spool 420 may be connected to the second end 404 of the connector 400. In another aspect contemplated herein, both the seat shell 200 and the base 300 have spools such that the first end 402 and the second end 404 of the connector 400 may each be wound around the spool when in the non-extended position and the connector 400 may at least partially unwind at both ends 402 and 404 when it moves to an extended position.

Further, as described herein, aspects of the seat shell 200 may be rotatable with respect to the base 300. As such, the connector 400 may be secured to the seat shell 200 and the base 300 at portions of the respective components that are positioned along a rotation axis. For example, the seat shell 200 rotates about a rotation axis 260 as it rotates with respect to the base 300. As such, the first end 402 of the connector 400 may be secured to the base 300 along the rotation axis 260 and the second end 404 of the connector 400 may be secured to the seat shell 200 along the rotation axis 260. In this way, the connector 400 itself may generally extend along the rotation axis 260. Extension along the rotation axis 260 allows the seat shell 200 to be rotated relative to the base 300 while the connector 400 maintains connection between the seat shell 200 and base 300. In some aspects, the connector 400 may rotate with rotation of the seat shell 200 relative to the base 300 at least partly due to friction between the second end 404 of the connector 400 and seat shell 200, but the friction may be overcome when sufficient tension is applied via rotation such that the connector 400 may be rotated relative to the seat shell 200 so that the connector 400 can be rotated independently of rotation of the seat shell 200. In some aspects, the connector 400 is freely rotatable with respect to the seat shell 200 without initially being rotated by the rotation of the seat shell 200. Further, in some examples, the first end 402 and/or the second end 404 may be attached to the base 300 and the seat shell 200, respectively, at a position that is not along the rotation axis 260.

FIG. 6B includes a close-up view of the second end 404 of the connector 400. The second end 404 extends through an aperture 422 in the bottom side 213 of the seat bottom 209. The second end 404 further includes a projection 424, such as a mushroom cap, that has a diameter that is greater than the diameter of the aperture 422 in the seat bottom 209. The greater diameter of the projection 424 prevents the second end 404 from slipping out from the aperture 422 while also allowing the connector 400 to freely rotate within the seat bottom 209. In other embodiments, the aperture 422 and projection 424 at the second end 404 of the connector 400 may be in addition to a similar aperture and projection at the first end 402 of the connector 400 to connecting the first end 402 to the base 300.

FIG. 6C depicts an alternative configuration of the connector 400 with a close-up view of the second end 404. In the configuration depicted in FIG. 6C, the connector 400 includes a first segment 401A and a second segment 401B that extend generally parallel to one another between the base 300 and the seat shell 200. The connector 400 includes a loop 403 between the first segment 401A and the second segment 401B. In other words, the connector 400 folds over itself. As such, the loop 403 forms the second end 404 of the connector 400. It will be appreciated that in other aspects, the first end 402 of the connector 400 may additionally or alternatively be formed of a loop similar to the loop 403. The loop 403 extends at least partially around an anchor 405 that is configured to secure to the connector 400 to the seat shell 200 (or, in other aspects, the base 300). Examples of the anchor 405 may include a single bar or rod, a cross-bar, an open hook, a closed hook, and the like. In some aspects, the anchor 405 is rotatably attached to the seat shell 200 to enable the seat shell 200 to rotate relative to the connector 400 to as the seat shell 200 is rotated relative to the base 300. In this example depicted in FIG. 6C, the connector 400 is folded such that the first segment 401A and the second segment 401B each extend from and are secured to the base 300. However, it is understood, that the second segment 401B may be joined to the first segment 401A at a position along the first segment 401A such that only the first segment 401A is directly attached to the base 300.

In exemplary aspects, the connector 400 is a single component and is the only point of connection between the seat shell 200 and the base 300 when the seat shell 200 is in the second position (i.e., removed from the receiving portion 310 of the base). In other words, the car seat 10 may have only one connector 400. However, it is contemplated that other aspects of the disclosure include the car seat 10 having two connector components with features described with respect to the connector 400 to secure the seat shell 200 to the base 300 when the seat shell 200 is in the second position.

Further, in some aspects, the connector 400 is configured to allow for a sufficient degree of separation between the seat shell 200 and base 300 when the seat shell 200 is in the second (partially uncoupled) position. This degree of separation may be sufficient to permit the seat shell 200 to sit on a surface, such as a vehicle seat surface, next the base 300 while a user accesses portions of the car seat 10 during installation, as shown in FIG. 4A. Because the seat shell 200 can sit on a surface adjacent the base 300, a user does not have to hold up the seat shell 200 and, therefore, has both hands available to install or otherwise adjust the car seat installation settings. Further, the connector 400 may extend sufficiently to allow for the seat shell 200 to be placed on a surface next to the base 300 without applying excessive pressure to the connection points between the connector 400 and the base 300 and/or seat shell 200. In one example, the connector 400 allows for at least 10 inches between the previously abutting surfaces (e.g., the lower surface 215 of the seat bottom 209 and the support surface 358 of the base 300). In some aspects, the connector 400 allows for at least 12 inches, at least 16 inches, or at least 24 inches between the previously abutting surfaces (e.g., the lower surface 215 of the seat bottom 209 and the support surface 358 of the base 300).

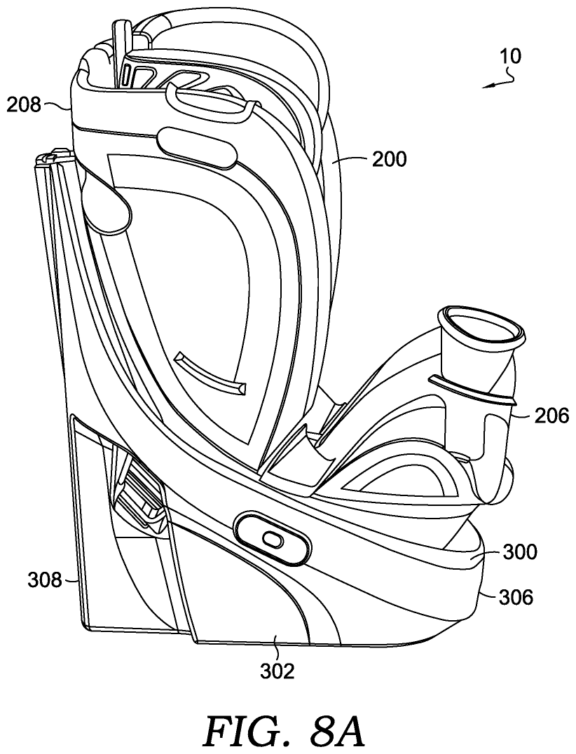

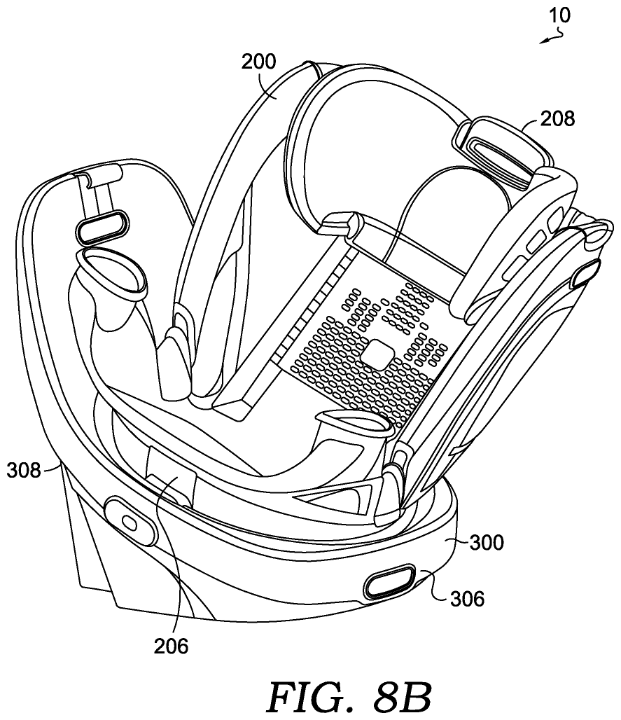

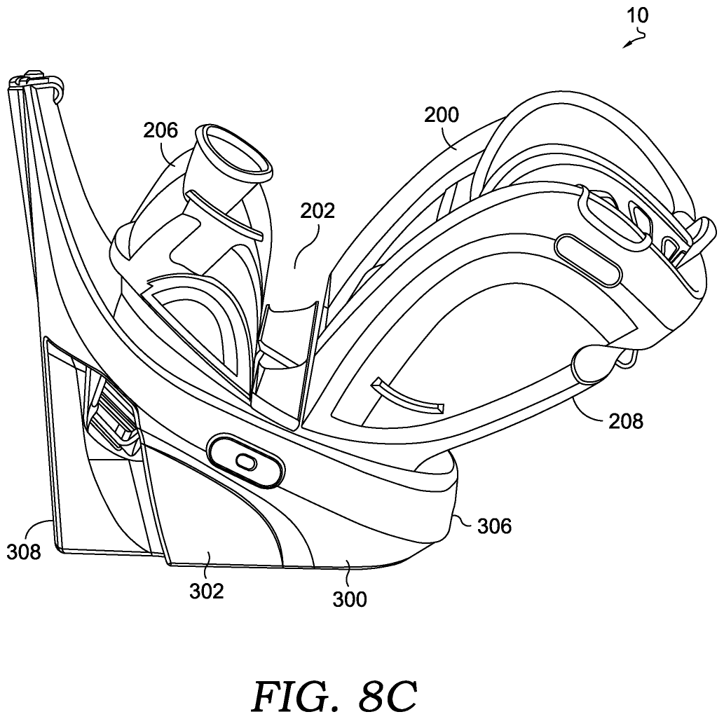

As previously indicated, in some aspects, the seat shell 200 is rotatable with respect to the base 300. The seat shell 200 may be rotated to be selectively positionable in a variety of different positions (e.g., a rearward-facing position, a forward-facing position, an intermediate loading position). FIGS. 8A-8C depict different positions of the seat shell 200 as it is rotated with respect to the base 300. FIG. 8A illustrates the seat shell 200 supported on the base 300 in a forward-facing position. With reference to FIG. 8A, in the forward-facing position, a forward end 206 of the seat shell 200 and a forward end 306 of the base 300 face a common direction (e.g., toward the forward end of the vehicle when installed), and a rear end 208 of the seat shell 200 and a rear end 308 of the base 300 face a common direction (e.g., toward the rear end of the vehicle when installed). FIG. 8C depicts the seat shell 200 supported on the base 300 in a rearward-facing position. As can be readily understood with reference back to FIGS. 8A and 8C, the seat shell 200 is rotated with respect to the base 300 about 180 degrees between the forward-facing position and the rearward-facing position. FIG. 8B depicts the seat shell 200 in an intermediate position as it is rotated between the forward-facing position in FIG. 8A and the rearward-facing position in FIG. 8C. In the intermediate position, the forward end 206 of the seat shell 200 faces a direction between the forward end 306 of the base 300 and the rear end 308 of the base 300 (e.g., such that, when installed, the forward end 306 of the seat shell 200 is toward a vehicle side door between the forward and rear ends of the vehicle), and the rear end 208 of the seat shell 200 faces a direction between the forward end 306 of the base 300 and the rear end 308 of the base 300 (e.g., such that, when installed, the rear end 308 of the seat shell 200 is away from the side door between the forward and rear ends of the vehicle when installed).

As may now be appreciated, the seat shell 200 may generally be rotated with respect to the base 300 between the forward-facing position and the rearward-facing position as the base 300 remains installed and stationary in the vehicle. Further yet, the seat shell 200 may generally be rotated any desired amount with respect to the base 300 (including being rotated a full 360 degrees). As may further be appreciated, the seat shell 200 is rotatable with respect to the base 300 to a variety of intermediate positions between the forward-facing position and the rearward-facing position. In this regard, it is specifically contemplated that the seat shell 200 may be rotatable with respect to the base 300 about 90 degrees in both a clockwise direction and a counterclockwise direction to intermediate positions. In this way, the car seat 10 is adapted to be usable on either the driver's side or passenger's side of a vehicle and equally provides ease for a user to place a child into the car seat 10 from a side door of the vehicle with the seat shell 200 generally facing the user. For example, in the intermediate position illustrated in FIG. 8B, the seat shell 200 generally faces the passenger's side door of the vehicle and advantageously enables the user to quickly and easily place or remove a child from the car seat 10 while facing the child.

Further details of an example mechanisms in a car seat for selectively rotating a seat shell with respect to a base and locking an unlocking the seat shell to the base in different positions is described in U.S. Pat. No. 11,427,114, issued Aug. 30, 2022. Some embodiments of the car seat 10 may include such mechanisms, and the disclosure of U.S. Pat. No. 11,427,114 is hereby incorporated by reference in its entirety.

In exemplary aspects, the seat shell 200 has one or more engagement features that engage or mate with a respective engagement feature on the base 300 to keep the seat shell 200 positioned within the receiving portion 310 of the base 300 and/or lock rotation of the seat shell 200 with respect to the base 300 at one or more positions. In this way, an engagement feature on the seat bottom 209 of the seat shell 200 may selectively lock with an corresponding engagement feature of the receiving portion 310 of the base 300 so that when the seat shell 200 is in the second portion, the engagement features of the seat shell 200 and base 300 may be disengaged from each other to permit some separation while the connector 400 may prevent the seat shell 200 and the base 300 from completely separating. Embodiments of various engagement/retaining features and locks are described further in U.S. Pat. No. 11,427,114, the disclosure of which is incorporated herein in its entirety.

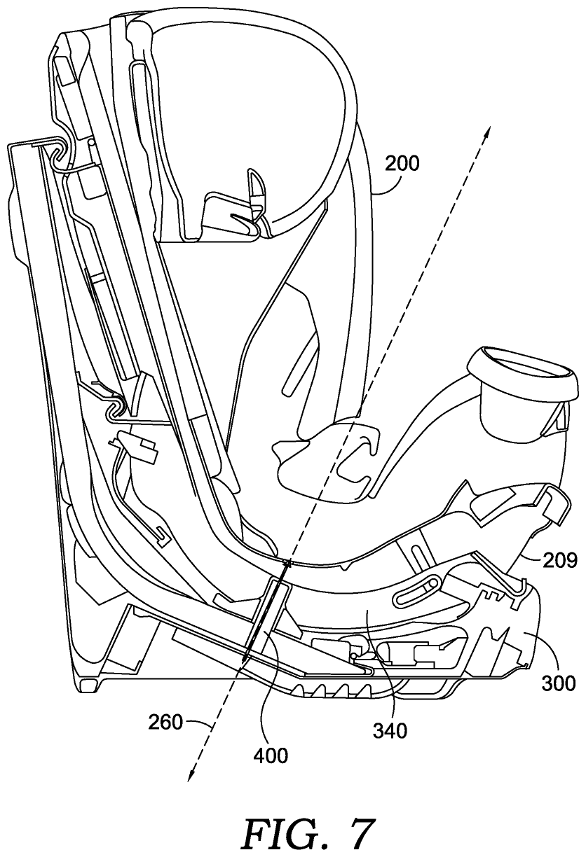

In some embodiments, the seat shell 200 includes a recline mechanism, such as recline mechanism 340 in FIG. 7, that generally operates to permit the seat shell 200 to be reclinable with respect to the base 300. In particular, the seat shell 200 may travel (e.g., slidably or otherwise) along a reclination path (e.g., an arcuate reclination path) defined by the recline mechanism. In this way, the complementary shapes of the bottom side 213 of the seat bottom 209 of the seat shell 200 and the receiving portion 310 of the base 300 may advantageously assist in smooth travel of the seat shell 200 as the seat shell 200 is reclined with respect to the base 300. In some aspects, the car seat 10 may include a recline mechanism as disclosed in U.S. Pat. No. 11,427,114, the entirety of which is incorporated herein by reference.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A car seat, comprising: a base including a receiving portion; a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and a connector having a first end and a second end opposite the first end, the first end of the connector being secured to the base and the second end being secured to the bottom side of the seat bottom, wherein the connector maintains connection between the base and the seat shell when the seat shell is in the second position.

Clause 2. The car seat of clause 1, wherein the connector moves between a non-extended position when the seat shell is in the first position and an extended position when the seat shell is in the second position.

Clause 3. The car seat of clauses 1 or 2, wherein the connector is a retractable connecting piece having a first length between the first end and the second end in the non-extended position and a second length between the first end and the second end in the extended position.

Clause 4. The car seat of any of clauses 1 through 3, wherein the first end of the connector is secured to a spool at least partially positioned in the base.

Clause 5. The car seat of any of clauses 1 through 4, wherein the connector has slack in the non-extended position and is taut when in the extended position.

Clause 6. The car seat of any of clauses 1 through 5, wherein the connector comprises a cable.

Clause 7. The car seat of any of clauses 1 through 6, wherein the first end of the connector is secured to a central portion of the base in the receiving portion.

Clause 8. The car seat of any of clauses 1 through 7, wherein the car seat includes only one connector.

Clause 9. The car seat of any of clauses 1 through 8, wherein when the seat shell is in the second position, the bottom side of the seat bottom is positioned at a distance from the receiving portion of the base, wherein the distance is at least 12 inches.

Clause 10. The car seat of any of clauses 1 through 9, wherein the seat bottom includes an engagement feature that selectively locks with an engagement feature of the receiving portion of the base, wherein when the seat shell is in the second position, the engagement feature of the seat bottom is disengaged from the engagement feature of the receiving portion.

Clause 11. The car seat of any of clauses 1 through 10, wherein the seat shell is rotatable about a rotation axis with respect to the base such that the seat shell is selectively positionable between at least a rearward-facing position and a forward-facing position.

Clause 12. The car seat of clause 11, where the first end of the connector is secured to a portion of the base that is located along the rotation axis.

Clause 13. A car seat, comprising: a base including a receiving portion; a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and a connector having a first end and a second end opposite the first end, the first end of the connector being secured to the base and the second end being secured to the seat shell, wherein the connector maintains connection between the base and the seat shell when the seat shell is in the second position, wherein the connector is a retractable connecting piece having a first length in a non-extended position when the seat shell is in the first position and having a second length in an extended position when the seat shell is in the second position.

Clause 14. The car seat of clause 13, wherein the first end of the connector is secured to a spool at least partially positioned in the base.

Clause 15. The car seat of clauses 13 or 14, wherein the second end of the connector is secured to the bottom side of the seat bottom.

Clause 16. The car seat of any of clauses 13 through 15, wherein the connector comprises a cable.

Clause 17. The car seat of any of clauses 15 through 16, wherein the first end of the connector is secured to a central portion of the base in the receiving portion.

Clause 18. The car seat of any of clauses 13 through 17, wherein the car seat includes only one connector.

Clause 19. The car seat of any of clauses 13 through 18, wherein when the seat shell is in the second position, the bottom side of the seat bottom is positioned at a distance from the receiving portion of the base, wherein the distance is at least 12 inches.

Clause 20. The car seat of any of clauses 13 through 19, wherein the seat bottom includes an engagement feature that selectively locks with an engagement feature of the receiving portion of the base, wherein when the seat shell is in the second position, the engagement feature of the seat bottom is disengaged from the engagement feature of the receiving portion.

Clause 21. The car seat of any of clauses 13 through 20, wherein the seat shell is rotatable about a rotation axis with respect to the base such that the seat shell is selectively positionable between at least a rearward-facing position and a forward-facing position.

Clause 22. The car seat of clause 21, where the first end of the connector is secured to a portion of the base that is located along the rotation axis.

Clause 23. A car seat, comprising: a base including a receiving portion; a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and a connector having a first end and a second end opposite the first end, the first end of the connector being secured to the base and the second end being secured to the seat shell, wherein the connector maintains connection between the base and the seat shell when the seat shell is in the second position, wherein the connector is a single connecting piece and is the only connection between the base and the seat shell when the seat shell is in the second position.

Clause 24. The car seat of clause 23, wherein the connector moves between a non-extended position when the seat shell is in the first position and an extended position when the seat shell is in the second position.

Clause 25. The car seat of clause 24, wherein the connector is a retractable connecting piece having a first length between the first end and the second end in the non-extended position and a second length between the first end and the second end in an extended position.

Clause 26. The car seat of any of clauses 23 through 25, wherein the first end of the connector is secured to a spool at least partially positioned in the base.

Clause 27. The car seat of any of clauses 24 through 26, wherein the connector has slack in the non-extended position and is taut when in the extended position.

Clause 28. The car seat of any of clauses 23 through 27, wherein the connector comprises a cable.

Clause 29. The car seat of any of clauses 23 through 28, wherein the first end of the connector is secured to a central portion of the base in the receiving portion.

Clause 30. The car seat of any of clauses 23 through 29, wherein the second end of the connector is secured to the bottom side of the seat bottom.

Clause 31. The car seat of any of clauses 23 through 30, wherein when the seat shell is in the second position, the bottom side of the seat bottom is positioned at a distance from the receiving portion of the base, wherein the distance is at least 12 inches.

Clause 32. The car seat of any of clauses 23 through 31, wherein the seat bottom includes an engagement feature that selectively locks with an engagement feature of the receiving portion of the base, wherein when the seat shell is in the second position, the engagement feature of the seat bottom is disengaged from the engagement feature of the receiving portion.

Clause 33. The car seat of any of clauses 23 through 32, wherein the seat shell is rotatable about a rotation axis with respect to the base such that the seat shell is selectively positionable between at least a rearward-facing position and a forward-facing position, wherein the connector extends parallel to the rotation axis.

Clause 34. The car seat of clause 33, wherein the first end of the connector is secured to a portion of the base that is located along the rotation axis.

Clause 35. A car seat, comprising: a base including a receiving portion; a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion, the seat shell being rotatable about a rotation axis with respect to the base; and a connector having a first end and a second end opposite the first end, the first end of the connector being secured to the base and the second end being secured to the seat shell, wherein the connector extending parallel to the rotation axis and maintains connection between the base and the seat shell when the seat shell is in the second position.

Clause 36. The car seat of clause 35, wherein the connector moves between a non-extended position when the seat shell is in the first position and an extended position when the seat shell is in the second position.

Clause 37. The car seat of clause 36, wherein the connector is a retractable connecting piece having a first length between the first end and the second end in the non-extended position and a second length between the first end and the second end in an extended position.

Clause 38. The car seat of any of clauses 35 through 37, wherein the first end of the connector is secured to a spool at least partially positioned in the base.

Clause 39. The car seat of any of clauses 36 through 38, wherein the connector has slack in the non-extended position and is taut when in the extended position.

Clause 40. The car seat of any of clauses 35 through 39, wherein the connector comprises a cable.

Clause 41. The car seat of any of clauses 35 through 40, wherein the first end of the connector is secured to a central portion of the base in the receiving portion.

Clause 42. The car seat of any of clauses 35 through 41, wherein the car seat includes only one connector.

Clause 43. The car seat of any of clauses 35 through 42, wherein when the seat shell is in the second position, the bottom side of the seat bottom is positioned at a distance from the receiving portion of the base, wherein the distance is at least 12 inches.

Clause 44. The car seat of any of clauses 35 through 43, wherein the seat bottom includes an engagement feature that selectively locks with an engagement feature of the receiving portion of the base, wherein when the seat shell is in the second position, the engagement feature of the seat bottom is disengaged from the engagement feature of the receiving portion.

Clause 45. The car seat of any of clauses 35 through 44, wherein the first end of the connector is secured to a portion of the base that is located along the rotation axis.

While particular exemplary embodiments have been described, it is not intended that the claims be limited thereto, as it is intended that the claims be as broad in scope as the art will allow and that the specification be read likewise. That is, the foregoing description of specific embodiments will so fully reveal the general nature of the disclosure that others may, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It will be appreciated by those of ordinary skill in the art that the components, method steps and materials illustrated above may be varied by substitution of equivalent components, steps and materials capable of performing the same functions. It will also be appreciated by one of ordinary skill in the art that sizes and strengths of the components may be scaled up or down as required for specific purposes. The claims hereof are intended to encompass all such equivalent components, method steps and scales.

What is claimed is:

1. A car seat, comprising:
a base including a receiving portion;
a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and
a connector having a first end and a second end opposite the first end, the first end of the connector being secured to the base and the second end being secured to the bottom side of the seat bottom, wherein the connector maintains connection between the base and the seat shell when the seat shell is in the second position.

2. The car seat of claim 1, wherein the connector moves between a non-extended position when the seat shell is in the first position and an extended position when the seat shell is in the second position.

3. The car seat of claim 2, wherein the connector is a retractable connecting piece having a first length between the first end and the second end in the non-extended position and a second length between the first end and the second end in an extended position.

4. The car seat of claim 3, wherein the first end of the connector is secured to a spool at least partially positioned in the base.

5. The car seat of claim 1, wherein the first end of the connector is secured to a central portion of the base in the receiving portion.

6. The car seat of claim 1, wherein the car seat includes only one connector.

7. The car seat of claim 1, wherein when the seat shell is in the second position, the bottom side of the seat bottom is positioned at a distance from the receiving portion of the base, wherein the distance is at least 12 inches.

8. A car seat, comprising:
a base including a receiving portion;
a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and
a connector having a first end and a second end opposite the first end, the first end of the connector being secured to the base and the second end being secured to the seat shell, wherein the connector maintains connection between the base and the seat shell when the seat shell is in the second position, wherein the connector is a retractable connecting piece having a first length in a non-extended position when the seat shell is in the first position and having a second length in an extended position when the seat shell is in the second position.

9. The car seat of claim 8, wherein the first end of the connector is secured to a spool at least partially positioned in the base.

10. The car seat of claim 8, wherein the first end of the connector is secured to a central portion of the base in the receiving portion.

11. The car seat of claim 8, wherein the car seat includes only one connector.

12. The car seat of claim 8, wherein when the seat shell is in the second position, the bottom side of the seat bottom is positioned at a distance from the receiving portion of the base, wherein the distance is at least 12 inches.

13. The car seat of claim 8, wherein the connector has slack in the non-extended position and is taut when in the extended position.

14. The car seat of claim 8, wherein the seat shell is rotatable about a rotation axis with respect to the base such that the seat shell is selectively positionable between at least a rearward-facing position and a forward-facing position.

15. The car seat of claim 14, where the first end of the connector is secured to a portion of the base that is located along the rotation axis.

16. A car seat, comprising:
a base including a receiving portion;
a seat shell including a seat bottom and a seat back extending upwardly from the seat bottom, the seat bottom having a top side and a bottom side, the bottom side interfacing with the receiving portion of the base, wherein the seat bottom is configured to move away from the base such that, in a first position, at least part of a lower surface of the seat bottom abuts a surface of the receiving portion of the base and, in a second position, the bottom side of the seat bottom is separated from the surface of the receiving portion; and
a connector having a first end and a second end opposite the first end, the first end of the connector being secured to the base and the second end being secured to the seat shell, wherein the connector maintains connection between the base and the seat shell when the seat shell is in the second position, wherein the connector is a single connecting piece and is the only connection between the base and the seat shell when the seat shell is in the second position.

17. The car seat of claim 16, wherein the first end of the connector is secured to a spool at least partially positioned in a central portion of the base.

18. The car seat of claim 16, wherein when the seat shell is in the second position, the bottom side of the seat bottom is positioned at a distance from the receiving portion of the base, wherein the distance is at least 12 inches.

19. The car seat of claim 16, wherein the seat bottom includes an engagement feature that selectively locks with an engagement feature of the receiving portion of the base, wherein when the seat shell is in the second position, the engagement feature of the seat bottom is disengaged from the engagement feature of the receiving portion.

20. The car seat of claim 16, wherein the seat shell is rotatable about a rotation axis with respect to the base such that the seat shell is selectively positionable between at least a rearward-facing position and a forward-facing position, wherein the connector extends parallel to the rotation axis.
